(19) United States
(12) Patent Application Publication
(10) Pub. No.: US 2005/0239607 A1
(43) Pub. Date: Oct. 27, 2005

(54) Treadmill with front and rear inclination adjustment unit

(76) Inventor: Chih Yuan Chang, Daya Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/829,334

(22) Filed: Apr. 22, 2004

(51) Int. Cl. A63B 22/02; E06C 7/16

(52) U.S. Cl. 482/54

(57) ABSTRACT

A treadmill with front and rear inclination adjustment unit, including a base seat having two support arms, a tread platform mounted between the support arms and an inclination adjustment unit disposed between the tread platform and the base seat. The inclination adjustment unit has two symmetrical ascending/descending members and a telescopic rod. First ends of the ascending/descending members are respectively pivotally connected with inner sides of bottom ends of the support arms. Second ends of the ascending/descending members are respectively pivotally connected with two sides of front end of the tread platform. A connecting seat is disposed at a middle section of the transverse beam. The connecting seat has a connecting end extending in the same direction as the second end of the ascending/descending member, whereby the connecting end and the second end are positioned on the same side. The connecting end of the connecting seat is pivotally connected with one end of the telescopic rod. The other end of the telescopic rod is pivotally connected with a caster rack under the bottom of the rear end of the tread platform.

### BACKGROUND OF THE INVENTION

The present invention is related to a treadmill with front and rear inclination adjustment unit, and more particularly to a treadmill in which the front and rear inclinations of the tread platform can be adjusted and the height of the tread platform is lowered.

In a conventional treadmill, the front end of the tread platform generally can be lifted or lowered to change the gradient of the tread platform and achieve better exercising effect. However, the front end of the tread platform can be simply lifted and cannot be downward inclined. Therefore, the conventional cannot provide a down gradient training.

FIG. 6 shows an improved treadmill which overcomes the shortcoming of the conventional treadmill. A linking device 8 is disposed under the tread platform 71 of the treadmill. The linking device 8 has an adapting board 81 pivotally disposed under the middle of the tread platform 71. The adapting board 81 is connected with a front link 82 and a rear link 83. The other end of the front link 82 is connected with a front wheel bracket 84. The other end of the rear link 83 is connected with a rear wheel bracket 85. The front wheel bracket 84 is driven by a driving means 86 so as to drive the front and rear links 82, 83, the adapting board 81 and the rear wheel bracket 85. Accordingly, the front and rear ends of the tread platform 71 can be lifted to achieve up gradient and down gradient training.

In the above structure, a restricting lever 73 must be disposed between the tread platform 71 and the base seat 72 to achieve a restricting effect for the tread platform 71. However, both the position and height of the restricting lever 73 and the adapting board 81 will lead to increment of the height of the tread platform 71. Therefore, the tread platform 71 is spaced from the ground by a considerable distance. This makes it more dangerous to exercise on the tread platform.

### SUMMARY OF THE INVENTION

It is therefore a primary object of the present invention to provide a treadmill with front and rear inclination adjustment unit. The treadmill includes a base seat, a tread platform and an inclination adjustment unit.

The base seat has two support arms respectively upward extending from two sides of the base seat. The front end of the tread platform is mounted between the two support arms of the base seat. The tread platform is looped by a tread belt. The bottom of rear end of the tread platform is pivotally connected with one end of a caster rack with which the inclination adjustment unit is pivotally connected.

The inclination adjustment unit has two symmetrical ascending/descending members and a telescopic rod. Each ascending/descending member has a first end and a second end. The first ends of the ascending/descending members are respectively pivotally connected with inner sides of bottom ends of the support arms. The second ends of the ascending/descending members are respectively pivotally connected with two sides of front end of the tread platform. The first ends are positioned in front of the second ends. A transverse beam is fixedly connected between middle sections of the ascending/descending members. One end of the telescopic rod is pivotally connected with the transverse beam. The other end of the telescopic rod is pivotally connected with the caster rack under the bottom of the rear end of the tread platform. It is unnecessary to reserve a pivoting space under the tread platform for the restricting lever and adapting board. In addition, the first ends of the ascending/descending members are pivotally connected with the support arms of the base seat near bottom end thereof. Also, the caster rack can be folded and positioned under bottom side of the tread platform. Therefore, the height of the tread platform from the ground is effectively reduced so that the tread platform is closer to the bottom face. This enhances the safety of the user when exercising.

It is a further object of the present invention to provide the above treadmill with front and rear inclination adjustment unit. The telescopic rod can drive the ascending/descending members and the caster rack to pivot so as to adjust the heights of the front end and rear end of the tread platform. Therefore, the tread platform can form an up gradient with higher front end and lower rear end or a down gradient with lower front end and higher rear end. Therefore, the inclination of the tread platform is more variable so as to achieve different training effect.

The present invention can be best understood through the following description and accompanying drawings wherein:

### BRIEF DESCRIPTION OF THE DRAWINGS

FIG. 1 is a perspective assembled view of the present invention;

FIG. 2 is a perspective exploded view of the present invention;

FIG. 3 is a side view of the present invention, showing that the tread platform is not ascended/descended;

FIG. 4 is a side view according to FIG. 3, showing that the front end of the tread platform is lifted;

FIG. 5 is a side view according to FIG. 3, showing that the rear end of the tread platform is lifted; and

FIG. 6 is a side view of a conventional treadmill, showing the height adjustment unit of the tread frame.

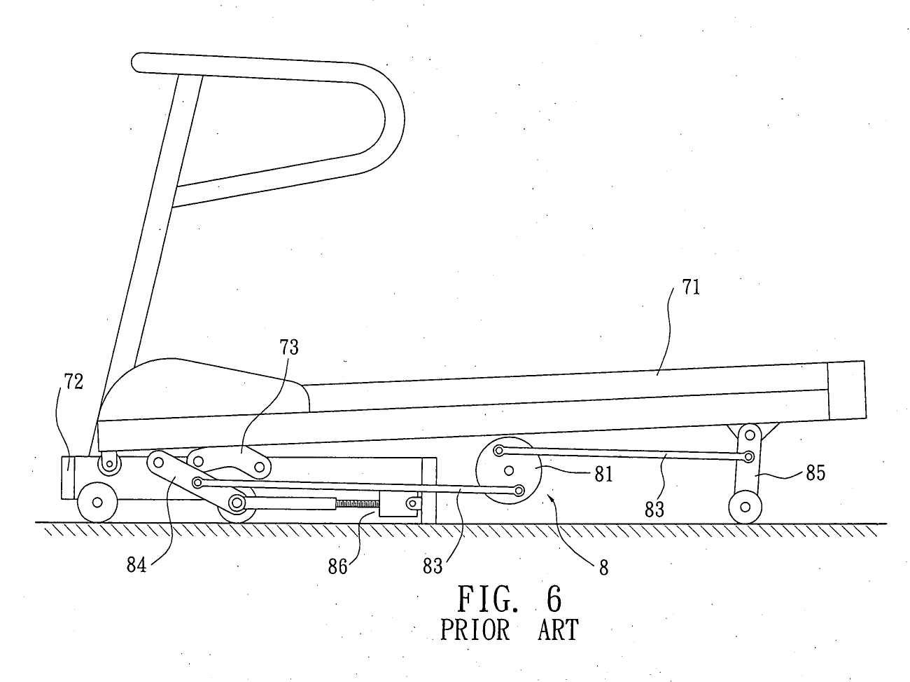

### DETAILED DESCRIPTION OF THE PREFERRED EMBODIMENT

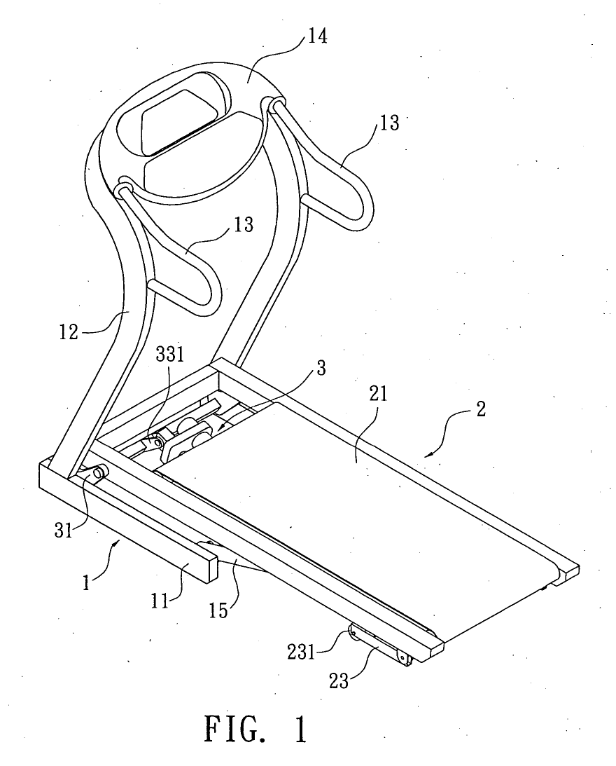

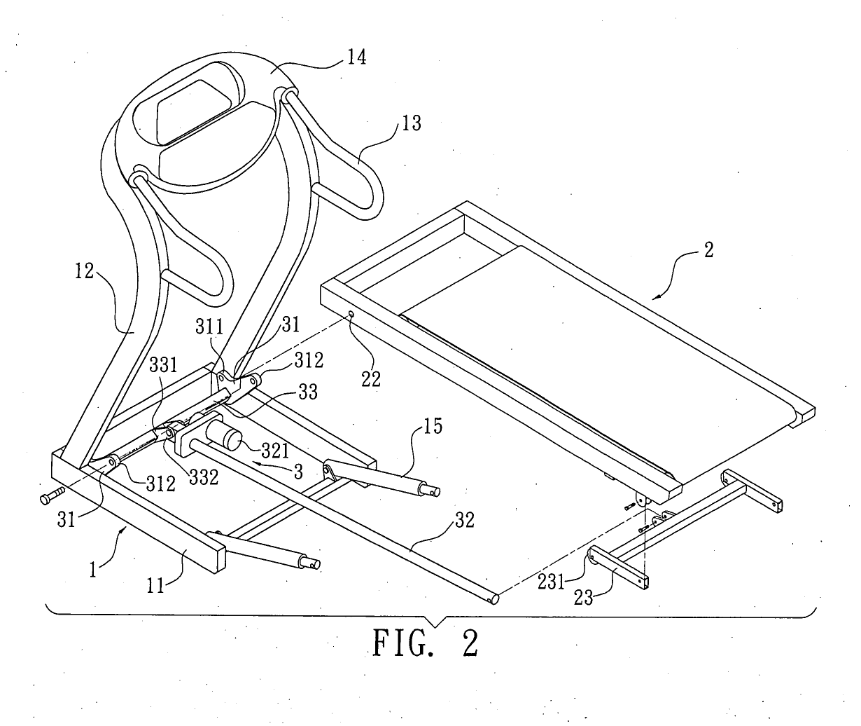

Please refer to FIGS. 1 to 3. The treadmill of the present invention includes a base seat 1, a tread platform 2 and an inclination adjustment unit 3.

The base seat 1 has two sidebars 11 on left and right sides. Two support arms 12 respectively upward extend from front ends of the sidebars 11. A rail 13 is mounted on top end of each support arm 12 for a user to hold. A control panel 14 is disposed between the two rails 13 for the user to adjust the running speed and gradient of the tread platform 2. A rear end of the sidebar 11 is pivotally connected with one end of an auxiliary rod 15. The other end of the auxiliary rod 15 is pivotally connected with each side of a middle section of the tread platform 2. In this embodiment, the auxiliary rod 15 is a pneumatic rod for helping in folding the treadmill.

The front end of the tread platform 2 is mounted between the two support arms 12. The tread platform 2 is looped by a tread belt 21 which is driven by a motor (not shown) to circularly revolve. Two sides of the front end of the tread platform 2 are respectively formed with two pivot holes 22. The bottom of rear end of the tread platform 2 is pivotally connected with one end of a caster rack 23. The caster rack 23 is pivotally connected with the inclination adjustment unit 3. Two casters 231 are respectively pivotally connected with two sides of the other end of the caster rack 23. In addition, an anti-collision cushion 24 is disposed under the tread platform 2 on front side of the caster rack 23.

The inclination adjustment unit 3 has two symmetrical ascending/descending members 31 and a telescopic rod 32. Each ascending/descending member 31 has an upward extending first end 311 and an upward extending second end 312 which contain a certain angle. The first end 311 of the ascending/descending member 31 is pivotally connected with inner side of bottom end of the support arm 12. The second end 312 of the ascending/descending member 31 is pivotally connected at the pivot hole 22 of each side of the tread platform 2. A transverse beam 33 is fixedly connected between middle sections of the ascending/descending members 31 under the tread platform 2. A connecting seat 331 is disposed at a middle section of the transverse beam 33. The connecting seat 331 has a connecting end 332 extending in the same direction as the second end 312 of the ascending/descending member 31. Accordingly, the connecting end 332 and the second end 312 are positioned on the same side opposite to the first end 311. One end of the telescopic rod 32 is pivotally connected with the connecting end 332 of the connecting seat 331. The other end of the telescopic rod 32 is pivotally connected with the caster rack 23 under the tread platform 2. The telescopic rod 32 is driven by a power source 321 to telescope. In this embodiment, the telescopic rod 32 is a thread rod and the power source 321 is a lifting motor.

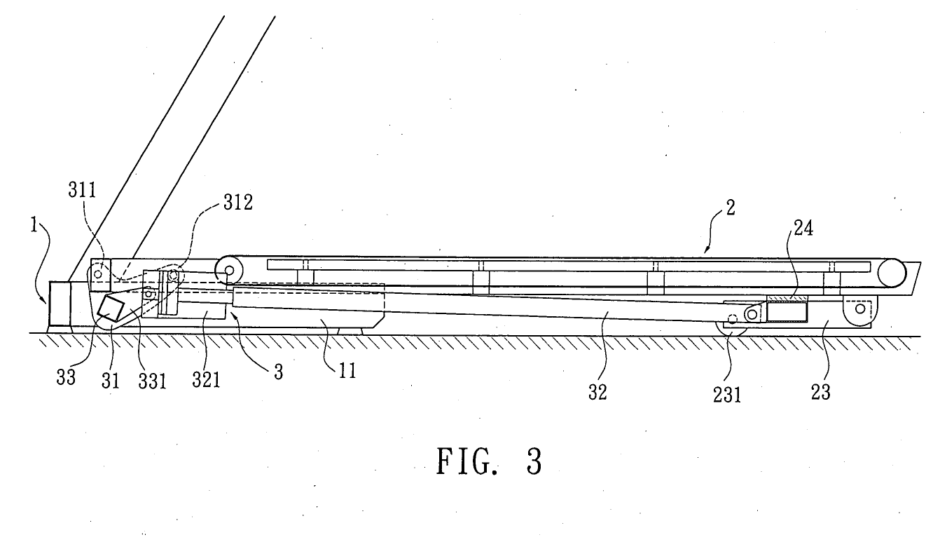

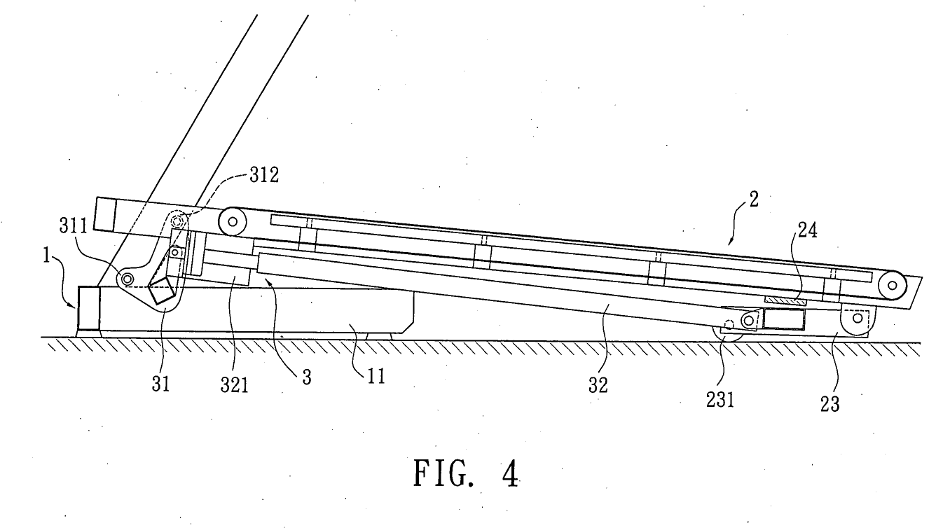

Please refer to FIGS. 3 and 4 which show the ascending/descending operation of the tread platform 2. By means of the power source 321, the telescopic rod 32 is controlled to telescope. At this time, the caster rack 23 is folded toward the tread platform 2 to abut against the anti-collision cushion 24. Therefore, when exercising, the tread platform 2 is prevented from colliding the caster rack 23. When the telescopic rod 32 telescopes, the angle contained between the second end 312 of the ascending/descending member 31 and the tread platform 2 is varied. The first end 311 of the ascending/descending member 31 is pivotally connected with the support arm 12 of the base seat 1, whereby the second ends 312 of the two ascending/descending members 31 pivotally connected with the tread platform 2 are turned upward about the first ends 311. Accordingly, the front end of the tread platform 2 is driven and ascended and thus the inclination of the up gradient of the tread platform 2 on the base seat 1 can be adjusted (as shown in FIG. 4). Reversely, when descending the tread platform 2, by means of the power source 321, the telescopic rod 32 is controlled to extend forward. At this time, the second ends 312 of the two ascending/descending members 31 pivotally connected with the tread platform 2 are turned downward so that the front end of the tread platform 2 is driven and descended.

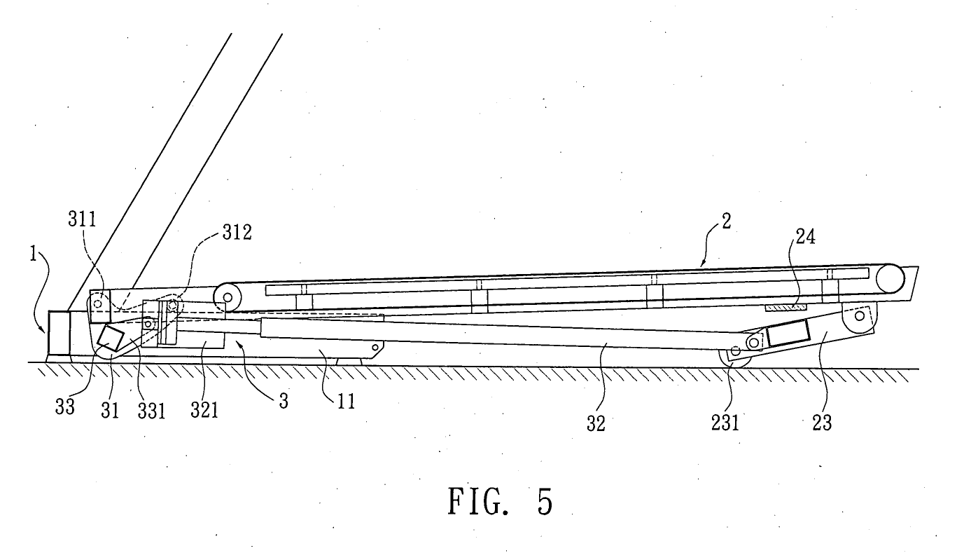

Please refer to FIG. 5 which shows that the front end of the tread platform is downward inclined for down gradient training. When the telescopic rod 32 such extends as to lower the front end of the tread platform 2 to touch the transverse beam 33 of the inclination adjustment unit, the ascending/descending members 31 are no more rotated. The telescopic rod 32 can further extend to drive the caster rack 23 to turn backward. The caster rack 23 is pivotally connected with the tread platform 2 so that via the length of the caster rack 23, the rear end of the tread platform 2 is lifted. Accordingly, the height of the rear end of the tread platform 2 is larger than the height of the front end of the tread platform 2 to form a down gradient.

The first ends 311 of the ascending/descending members 31 pivotally connected with the support arms 12 and the second ends 312 of the ascending/descending members 31 pivotally connected with the tread platform 2 upward extend to upper side of the tread platform 2. Moreover, the connecting end 332 and the second end 312 are positioned on the same side opposite to the first end 311. Therefore, the ascending/descending members 31 change the angle contained between the second ends 312 and the tread platform 2 to ascend/descend the tread platform 2. In contrast to the present invention, in the conventional treadmill, the front and rear ends of the tread platform are ascended/descended to form an up gradient and a down gradient. Therefore, it is unnecessary to reserve a pivoting space under the tread platform 2 for the restricting lever and adapting board. In addition, the first ends 311 of the ascending/descending members 31 are pivotally connected with the support arms 12 of the base seat 1 near bottom end thereof. Also, the caster rack 23 can be folded and positioned under bottom side of the tread platform 2. Therefore, the height of the tread platform 2 from the ground is effectively reduced so that the tread platform 2 is closer to the bottom face. This enhances the safety of the user when exercising.

Furthermore, the telescopic rod 32 can drive the caster rack 23 to pivot so as to adjust the height of the rear end of the tread platform 2, whereby the tread platform 2 can form a down gradient with lower front end and higher rear end. Therefore, the inclination of the tread platform 2 is more variable so as to achieve different training effect.

The above embodiment is only used to illustrate the present invention, not intended to limit the scope thereof. Many modifications of the above embodiment can be made without departing from the spirit of the present invention.

1. A treadmill with front and rear inclination adjustment unit, comprising a base seat, a tread platform and an inclination adjustment unit, wherein:
the base seat has two support arms respectively upward extending from two sides of the base seat, a front end of the tread platform being mounted between the two support arms of the base seat, the tread platform being looped by a tread belt, a bottom of rear end of the tread platform being pivotally connected with one end of a caster rack with which the inclination adjustment unit is pivotally connected; and
the inclination adjustment unit has two symmetrical ascending/descending members and a telescopic rod, each ascending/descending member having a first end and a second end, the first ends of the ascending/descending members being respectively pivotally connected with inner sides of bottom ends of the support arms, the second ends of the ascending/descending members being respectively pivotally connected with two sides of front end of the tread platform, the first ends being positioned in front of the second ends, a transverse beam being fixedly connected between middle sections of the ascending/descending members, one end of the telescopic rod being pivotally connected with the transverse beam, the other end of the telescopic rod being pivotally connected with the caster rack under the bottom of the rear end of the tread platform.

2. The treadmill with front and rear inclination adjustment unit as claimed in claim 1, wherein the base seat has two sidebars on left and right sides, the two support arms being respectively disposed on front ends of the sidebars, a rail being mounted on top end of each support arm, a control panel being disposed between the two rails, the tread belt of the tread platform being driven by a motor to circularly revolve, two sides of the front end of the tread platform being respectively formed with two pivot holes, the second ends of the ascending/descending members being pivotally connected at the pivot holes of the tread platform, the bottom of rear end of the tread platform being pivotally connected with the caster rack which is pivotally connected with one end of the telescopic rod.

3. The treadmill with front and rear inclination adjustment unit as claimed in claim 2, wherein a rear end of each sidebar is pivotally connected with one end of an auxiliary rod, the other end of the auxiliary rod being pivotally connected with each side of a middle section of the tread platform.

4. The treadmill with front and rear inclination adjustment unit as claimed in claim 1, wherein the telescopic rod is driven by a power source to telescope.

5. The treadmill with front and rear inclination adjustment unit as claimed in claim 4, wherein the telescopic rod is a thread rod and the power source is a lifting motor.

6. The treadmill with front and rear inclination adjustment unit as claimed in claim 1, wherein the first and second ends of the ascending/descending members upward extend and contain a certain angle.

7. The treadmill with front and rear inclination adjustment unit as claimed in claim 1, wherein an anti-collision cushion is disposed under the tread platform on front side of the caster rack.

8. The treadmill with front and rear inclination adjustment unit as claimed in claim 1, wherein a connecting seat is disposed at a middle section of the transverse beam, the connecting seat having a connecting end extending in the same direction as the second end of the ascending/descending member, whereby the connecting end and the second end are positioned on the same side opposite to the first end, the connecting end of the connecting seat being pivotally connected with telescopic rod.
